(19) United States
(12) Patent Application Publication
(10) Pub. No.: US 2023/0116842 A1
(43) Pub. Date: Apr. 13, 2023

(54) SYSTEMS AND METHODS FOR VERIFYING USE OF PERSONAL SAFETY EQUIPMENT

(71) Applicant: INVENTIO AG, Hergiswil (CH)

(72) Inventor: Dieter RIEGELHOF, Uster (CH)

(21) Appl. No.: 17/913,311

(22) PCT Filed: Mar. 26, 2021
(86) PCT No.: PCT/EP2021/057902

§ 371 Date: Sep. 21, 2022

(30) Foreign Application Priority Data
Mar. 27, 2020 (EP) 20166280.6

(51) Int. Cl. G06Q 10/0635; G08B 21/24

(52) U.S. Cl. CPC G06Q 10/0635; G08B 21/24

(57) ABSTRACT

A safety system includes a server for communicating with a software application running on a mobile phone of a user. The safety system assists the user to comply with a safety profile by generating a GUI that shows prescribed personal protective equipment (PPE) devices in form of a checklist. A PPE device is provided with a magnet and an RF module having a magnetic switch. In use, when the user properly wears the PPE device, the magnet causes the magnetic switch to close, and the RF module is ready for being scanned by the user’s mobile phone. To comply with the safety profile, the user must wear the PPE devices and may be required to provide them in accordance with prescribed sequence.

### TECHNICAL FIELD

The technology described herein generally relates to personal safety equipment a user may be required to have or to wear when exposed to a potentially hazardous situation. More particularly, the various embodiments of the technology described herein relate to a system that assists the user in using the personal safety equipment and a method of operating the system.

### SUMMARY

A user may be exposed to a potentially hazardous situation, e.g., when working at a construction site, operating a machine, or repairing or servicing an electromechanical installation or a means of transportation. To protect the user from bodily injury, the user may be required to have or to wear personal protective/safety equipment (hereinafter referred to as PPE). Examples of such PPE include helmets/hard hats, ear protection/earmuffs, safety/protective goggles, gloves, safety shoes, and fall protection kits/safety harnesses. Safety documents and instructions made available to the users may emphasize the required use of the PPE and describe its proper use. However, users may pay less attention to these requirements, e.g., because of repetitive work and a feeling that safety checks are not needed. Moreover, as some of these PPE examples may be inconvenient or cumbersome to use, or time-consuming to put on, a user may decide to forego using them. If a user is not properly protected by the PPE, any accident may have more severe consequences than with properly used PPE.

Despite the availability of these PPE examples, there is a need for a technology that further improves upon the safety of a user when exposed to a potentially hazardous situation.

Accordingly, one aspect of such an improved technology involves a method of operating a safety system having a server configured to wirelessly communicate with a first mobile communications device of a first user. In the safety system, at least one personal safety equipment (PPE) device is equipped with a radio frequency (RF) module available to the first user, and the first mobile communications device is provided with a software application configured to execute predetermined functions. The predetermined functions include causing the first mobile communications device to display a graphical user interface having information related to the first user’s use of the PPE device. A set of instructions is transmitted by the server to the first mobile communications device being identified by a first device identifier, wherein the set of instructions includes a specification of a safety profile defined for the first user and causes the software application to display a checklist on the graphical user interface based on the safety profile; the checklist lists the at least one PPE device. A data signal received by the server from the first mobile communications device is indicative of a status of the safety profile, and processed to determine the status of the safety profile. The status being indicative of the safety profile being complete and the first user having a safe status, or being incomplete and the first user having an unsafe state. A safe-state message is transmitted by the server to the first mobile communications device if the safety profile has been complied with; and an unsafe-state message is transmitted by the server to the first mobile communications device if the safety profile has not been complied with.

Another aspect involves a safety system having at least one personal safety equipment (PPE) device for use by a first user, and a server. The PPE device is equipped with a radio frequency (RF) module to be scanned by a first mobile communications device of the first user, wherein the first mobile communications device is provided with a software application configured to execute predetermined functions. The predetermined functions include causing the first mobile communications device to display a graphical user interface including information related to the first user’s use of the PPE device. The server is configured to wirelessly communicate with the first mobile communications device of the first user. The server includes a processor and a computer-readable storage medium that includes instructions that cause the processor to perform the following functions:
transmit a set of instructions to the first mobile communications device being identified by a first device identifier, the set of instructions comprising a specification of a safety profile defined for the first user and causing the software application to display a checklist on the graphical user interface based on the safety profile, wherein the checklist lists the at least one PPE device;
receive a data signal from the first mobile communications device indicative of a status of the safety profile;
process the received data signal to determine the status of the safety profile, the status being indicative of the safety profile being complied with and the first user having a safe status, or being not complied with and the first user having an unsafe state;
transmit a safe-state message to the first mobile communications device if the safety profile has been complied with; and
transmit an unsafe-state message to the first mobile communications device if the safety profile has not been complied with.

The technology described herein improves the safety of a user in that it ensures that the user complies with a safety profile. To comply with the safety profile, the user must wear the prescribed PPE devices and, in one embodiment, provide them in accordance with prescribed sequence. In one embodiment, nearby co-workers, a supervisor and/or a service center may be alerted that the user is in an unsafe state.

The technology provides exact information about what the user has done, at least in terms of a sequence of events. If, due to valid safety regulations, the user should first put on a safety helmet and only then the gloves, then the technology allows programming this sequence. If the user does not follow this sequence, the app of the mobile phone emits in one embodiment an alert message or alarm signal (acoustic and/or vibration) and a message that the sequence was not followed. Any required process that may already exist in certain work environment in the form of work instructions can now be systematically broken down into its sequence as well as into process and checked. The visual and/or acoustic signals of the app force the attention of the user concerned and reduce the risk associated with a monotonous or routine work process.

The described technology can also be used to take further preventive steps in case of incorrect handling of the PPE and/or non-compliance with the safety profile. For example, if the user fails to perform a (control) step correctly and is still ‘in motion’, the app can detect this motion and generate a systematic escalation. Any other user in the immediate vicinity of the user and, if necessary, the service control center can be informed in a targeted manner that a user is working with - for example, only one protective glove.

The technology uses location information, e.g., GPS data (geographic coordinates) obtained by the mobile phone in the app, to detect an employee who continues working in an unsafe state. The server is configured to recognize which other users are in the vicinity (proximity allocation). The basis for the calculation is provided by the geographic coordinates of the (other) mobile phones, wherein a desired monitoring distance or radius can be defined. In one embodiment, the server sends a message (Co-Worker nearby unsafe, or the like) - as well as the calculated distance in meters - to all mobile phones -with the installed app - which it detects within the set radius.

In one embodiment, a PPE device has a buckle configured to be closed when the PPE device is worn by the user. One part of the buckle is provided with an RF module having magnetic switch, a second part of the buckle having a magnet, and wherein the magnet and the magnetic switch are positioned to be in close proximity when the buckle is closed. Then, the magnet causes the magnetic switch to switch from an open state to a closed state closing an electrical circuit so that the RF module is operable. The RF module may be an RFID/NFC tag which can be switched on and off using a magnet. The closures of the PPE devices can be used as switches. This prevents the user from just scanning his PPE device, but not actually wearing it on his body. The RFID/NFC tag is inactive until the magnetic lock activates it, only then can the data from the RFID/NFC tag be read into the app.

### BRIEF DESCRIPTION OF THE DRAWINGS

The novel features and characteristics of the technology are set out in the claims below. The various embodiments of the technology, however, as well as other features and advantages thereof, are best understood by reference to the detailed description, which follows, when read in conjunction with the accompanying drawings, wherein:

FIG. 1 shows a schematic illustration of a variety of exemplary personal safety equipment devices available to a user;

FIG. 2 shows a schematic illustration of safety system for use in connection with at least one of the personal equipment devices of FIG. 1;

FIG. 3 is a schematic illustration of exemplary scenarios for using the safety system of FIG. 2; and

FIGS. 4a-4b show a flow diagram of one embodiment of a process for using the technology described herein including a method of operating the safety system.

### DETAILED DESCRIPTION

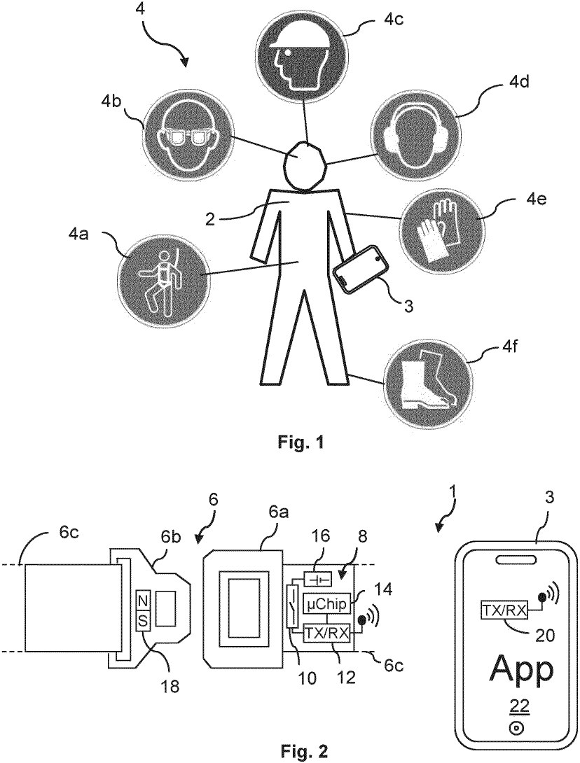

FIG. 1 is a schematic illustration of a variety of exemplary personal safety equipment (PPE) devices 4 available to a user 2 carrying a mobile communications device 3. In the embodiments described herein, a mobile communications device is a mobile phone, it may also be referred to as smartphone, as is known to the skilled person. The illustrated PPE devices 4 include a fall protection kit or safety harness 4a, safety/protective goggles 4b, a helmet/hard hat 4c, earmuffs 4d, right-hand and left-hand gloves 4e, and a pair of safety shoes 4f. Depending on a specific task the user 2 is performing, the user 2 may be required to wear at least one of these PPE devices 4. All or some of the PPE devices 4 can be provided with fastening devices that secure the PPE device 4 to the user’s body. For example, the safety harness 4a, the helmet 4c and the safety shoes 4f may be provided with buckles, closures or other fasteners. In certain embodiments, the safety goggles 4b and the gloves 4e may have such closures as well.

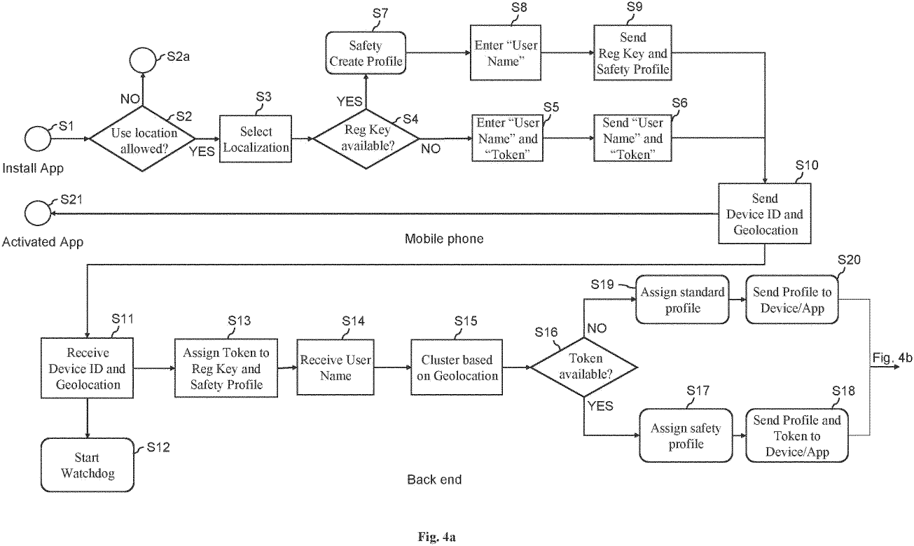

The user 2 may be a service technician scheduled for servicing, for example, an elevator installation. The organization that employs the user 2 may be the manufacturer of the elevator installation or a company authorized to service elevator installations. As such, the organization has access to the specification of the elevator installation (e.g., type, year of construction, etc.) and to data associated with the elevator installation (e.g., building address, height of the building, etc.). That information may be stored in a server 24 (FIG. 3) maintained by the organization, e.g., at a service center. The organization may specify certain targeted methodical patterns or procedures for its employees (e.g., the user 2) to perform after arrival on site. Initial steps of such a procedure include the requirement that the employees protect themselves.

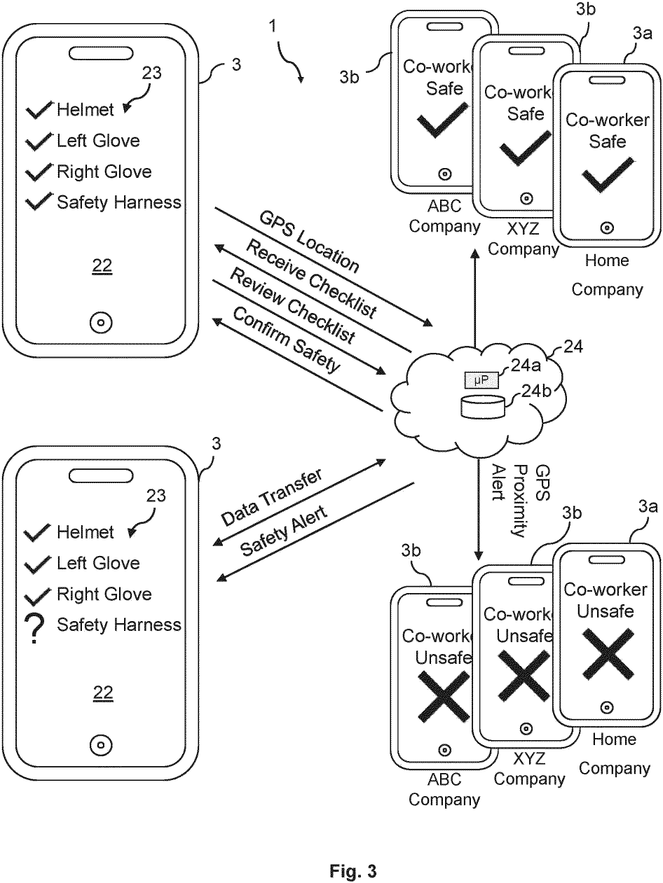

FIG. 2 shows a schematic illustration of one aspect of a safety system 1 for use in connection with at least one of the PPE devices 4 shown in FIG. 1. In the illustrated embodiment, one of the PPE devices 4 is provided with a buckle 6 as one example of a fastening device that secures the PPE device 4 to the user’s body. The buckle 6 includes a first part 6a and a second part 6b, both of which are attached to the PPE device 4, for example, to its straps 6c or another PPE device part. In use, the user 2 is required to close the buckle 6, e.g., mate the first and second parts 6a, 6b. In FIG. 2, the buckle 6 is shown in an open (unmated) state. It is contemplated that the fastening device is not limited to the illustrated buckle 6, that the buckle 6 may have any other two-part configuration, and that other fastening devices may be used, such as hook-and-loop fasteners, press buttons, snaps, ratchet buckles, etc.

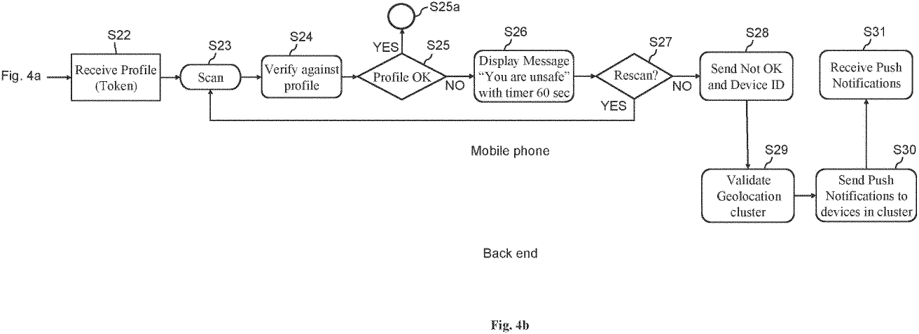

As shown in FIG. 2, the first part 6a includes a radio frequency (RF) module 8 configured to communicate with a corresponding RF module 20 of the mobile phone 3. The RF module 8 includes a transceiver 12 (TX/RX) with an antenna, a magnetic (ON/OFF) switch 10, a microchip 14, and an optional battery 16. If the RF module 8 is configured as an active RF module 8, the battery 16 provides the electrical energy required to operate the RF module 8, in particular its transceiver 12. In a passive RF module 8, the battery 16 is not required because electrical energy is obtained from electromagnetic waves received via the transceiver 12 and its antenna, e.g., when the mobile phone’s RF module 20 polls the buckle’s RF module 8. In the illustrated embodiment, the buckle’s RF module 8 is configured as an RFID transponder, and the mobile phone’s RF module 20 is configured as an RFID reader. Further details as to the operation of these modules 8, 20 are described in connection with FIGS. 3, 4a and 4b.

The second part 6a includes a magnet 18, illustrated in FIG. 2 as a dipole with north (N) and south (S) poles. On the buckle 6, or generally on the PPE device 4, the magnet 18 and the magnetic switch 10 are positioned to be in close proximity when the buckle 6 is closed. The magnet 18 causes the magnetic switch 10 to switch from an open state (as shown in FIG. 2) to a closed state. In the closed state, the magnetic switch 10 closes an electrical circuit and the buckle’s RF module 8 is operable. The magnetic switch 10 is configured to resume its open state as soon as the buckle 6 is opened and the magnet 18 and the magnetic switch 10 are thereby separated from each other. It is contemplated that the RF module 8 is not operable in the open state.

While the RF module 8 is operable, the user 2 may use the mobile phone 3 and a software application (app) running on the mobile phone 3 to scan (or poll) the RF module 8 and to read stored data from the microchip 14. The data stored on the microchip 14 identifies the PPE device 4. In one embodiment, the data identifies the PPE device 4 by specifying its kind (e.g., a glove 4e (left, right), a shoe 4f (left, right), a safety harness 4a, or a helmet 4c, etc.); it may further specify characteristics of the PPE device 4 (e.g., a safety rating, noise attenuation value for earmuffs 4d, or strength/radiation protection for safety goggles 4b. In another embodiment, the data includes a unique identifier (e.g., a number or an alphanumeric code) which is linked in a database (e.g., maintained at the server 24) to the PPE device 4 to which the RF module 8 mounted. Depending on the configuration of the app, information derived from the read data may be displayed on a graphical user interface (GUI) 22 of the mobile phone 3. Examples of how the GUI 22 may be implemented are shown in FIG. 3.

FIG. 3 is a schematic illustration of exemplary scenarios for using the safety system 1 of FIG. 2. In these scenarios, the user 2 is an employee of a company (referred to as the user’s home company) and is or works at a site where other users (referred to as co-workers) are present as well. A first scenario is shown in about the upper half of FIG. 3, and a second scenario is shown in about the lower half of FIG. 3. In each one of these scenarios, the user’s mobile phone 3 exchanges data with the server 24, which may relay information concerning the user 2 to the user’s home company or a home-company co-worker. FIG. 3 illustrates the latter aspect through a mobile phone 3a assigned to the home-company co-worker. In addition, or in the alternative, the server 24 may relay the information to one or more other companies or their workers; FIG. 3 illustrates that aspect through mobile phones 3b assigned to workers of ABC and XYZ companies.

As illustrated in FIG. 3, the server 24 includes a processor 24a (µP) and a computer-readable storage medium 24b. These components (24a, 24b) of the server 24 as such and the general operation of a server are known to the skilled person. The computer-readable storage medium 24b includes instructions that cause the processor 24a to execute certain aspects of the technology described herein.

In the illustrated scenarios, the user 2 is supposed to comply with a safety profile. In one embodiment, the safety profile specifies the one or more PPE devices 4 the user 2 must wear for a specified work assignment. The safety profile may specify that the user 2 must wear a helmet, a left glove, a right glove and a safety harness. It is contemplated that in another embodiment the user 2 may be required to wear another combination of PPE devices 4, for example, safety shoes in addition to or instead of the safety harness. In one embodiment, the safety profile may specify a sequence of acts the user 2 must follow when putting on the PPE devices 4. The mobile phone’s app is configured to present certain aspects of the safety profile, e.g., the required PPE devices 4, to the user 2 in form of a checklist 23 displayed on the GUI 22, as shown in FIG. 3. The checklist 23 may also specify the sequence of acts.

In the first scenario, the user’s mobile phone 3 displays a checkmark next to each PPE device of the checklist 23. This indicates that the user 2 wears the required PPE devices 4 and, hence, is considered to be in a safe state. The server 24 may convey that safe-state information to the mobile phones 3a, 3b of co-workers. These mobile phones 3a, 3b may display a corresponding information, e.g., using text and/or a symbol, as shown in FIG. 3 (upper half). In the second scenario, the displayed checklist 23 indicates that the user 2 does not wear the safety harness. The user 2 is, therefore, considered to be in an unsafe state. The server 24 may convey that unsafe-state information to the mobile phones 3a, 3b of co-workers. These mobile phones 3a, 3b may display a corresponding information, e.g., using text and/or a symbol, as shown in FIG. 3 (lower half). The data exchange between the mobile phones 3, 3a, 3b and the server 24 is described below in connection with FIGS. 4a and 4b.

FIGS. 4 and 4b show a flow diagram of one embodiment of a safety process for using the technology described herein, wherein the illustrated process includes a method of operating the safety system 1. It is contemplated that in another illustration of the flow diagram some of the shown steps may be merged into a single step or split into several separate steps. To provide context, some of the illustrated steps are described as performed by the user 2. It is contemplated, however, that the safety system 1 reacts to the user’s acts and executes corresponding tasks. The operational method is, therefore, generally performed by the safety system 1. The exemplary flow diagram starts at a step S1 and ends at a step S31.

In FIGS. 4a and 4b, the steps S1-S31 are arranged to illustrate that some of the steps are performed by the user’s mobile phone 3 and/or a software application being executed on the mobile phone 3 (upper part), and some of the steps are performed by the physical infrastructure (or hardware) of the safety system 1 or its software data access layer (lower part); the infrastructure and/or data access layer may be referred to as “back end”. For ease of reference, FIGS. 4a and 4b are labeled with “Mobile phone” in the upper part and “Back end” in the lower part. The server 24 shown in FIG. 3 may be part of the back end. In the embodiments described herein, the server 24 is operated by and/or assigned to the user’s home company. In FIGS. 4a and 4b, the steps S1-S10 and S21-S28 and S31 are performed by the mobile phone 3, and the steps S11-S20, S29 and S30 are performed by the server 24 (back end).

In the illustrated process, the steps S1-S6 concern an activation process of the software application (also referred to as app) for use with the technology described herein. It is contemplated that the software application is installed prior to its first use by the user 2 and is maintained as an activated app on the user’s mobile phone 3 for subsequent uses; this is indicated by step S21 shown in FIG. 4a.

Referring to the step S1 shown in FIG. 4a, the software application for use with the technology described herein is installed on the mobile phone 3. The installation may be initiated by the user 2 or other personnel of the user’s home company. In the embodiments described herein, the user 2 initiates the installation of the app.

Proceeding to the step S2, the user 2 is asked if the app is allowed to use location information. For example, the app may access a function provided by the mobile phone 3 that determines the current geographic location of the mobile phone 3. One example of such a function determines location data (e.g., location coordinates) by means of a positioning system, e.g., a navigational satellite-based positioning system, such as GPS/NAVSTAR GPS or Galileo. It is contemplated that the location data may be obtained by means of an indoor positioning system; the indoor positioning system may be used as an alternative to GPS or in addition to GPS, e.g., to enhance indoor accuracy. If the use is allowed, the process proceeds along the YES branch to the step S3. If the use is not allowed, the process proceeds along the NO branch to a step S2a and the process ends. In one embodiment, the mobile phone 3 may display a message indicating that the user 2 has not performed the safety procedure.

In the step S3, localization is selected. For example, the user 2 can select the country and the preferred language for the user’s interaction with the app.

Proceeding to the step S4, the process asks if a registration key (“Reg Key”) is available. The registration key provides that the user 2 can create his own safety profile. The registration key may be personal to the user 2 and can authorize the user 2 to create a safety profile, for example, because only some users employed by the home company may be allowed to create their own safety profile, wherein others may be required to use a fixed standard safety profile. As explained below, if there is no registration key, no token is created and the user 2 operates on a standard safety profile.

If the registration key is available, the process proceeds along the YES branch to the step S7. In the step S7, the safety profile is created. The safety profile creation may enable the user 2 from within the app to specify, for example, the PPE devices 4 the user 2 wants to wear generally, or only for certain work assignments. In addition, or in the alternative, the safety profile creation, in one embodiment, may enable the user 2 from within the app to create a sequence of safety checks which other users would have to follow, e.g., hardhat put on, gloves on, safety hook checked, etc. The user 2 may share his profile with his team or department. Once the safety profile is created, the process proceeds to the step S8.

In the step S8, the process allows the user 2 to enter a username. And in the step S9, the process sends the registration key and the safety profile created in the step S7 in connection with the username to the server 24. The process proceeds to the step S10.

Returning to the step S4, if the registration key is not available, the process proceeds along the NO branch to the step S5. In the step S5, the user 2 enters a username. After entering the username, the process requests entry of a token. The token is generated by the back end in the step S13 if a previous user has created a safety profile by using a registration key. The token is a unique alphanumeric code and transferred to the mobile phone 3. Other users can activate their app in the step S5 and automatically use the same safety profile that is associated with the token.

Proceeding to the step S6, the process sends the username and the token entered in the step S5 to the server 24. The process proceeds to the step S10.

In the step S10, the process causes sending a device identifier (device ID) of the mobile phone 3 to the server 24. The device ID is a unique identifier, e. g., a device code, a MAC address, or an IP address. Further, geolocation information is sent by the mobile phone 3 to the server 24. Geolocation is the identification or estimation of the real-world geographic location of an object, such as the mobile phone 3. The geolocation involves the generation of a set of geographic coordinates (latitude and longitude coordinates), but it may be enhanced by the use of these coordinates to determine a meaningful location, such as a street address.

Once the mobile phone 3 sent the information specified in steps S6, S9 and S10, the server 24 receives the geolocation and the device ID in the step S11. The mobile phone 3 identified by the device ID is added to a watchdog function module of the server 24, and a watchdog timer is started, as indicated in the step S12.

Proceeding to the step S13, if the app sent a registration key and a safety profile in the step S9 a unique token is created and assigned to that registration key and safety profile for later use (see step S5). All users who use the app with this token are subject to the same safety profile; this includes, for example, that the mobile phones of these users display the same checklist 23 (see FIG. 3)

Proceeding to the step S14, the username is received and stored at the server 24. It is contemplated that the server 24 is provided with a storage device or communicatively connected with a storage device.

Proceeding to the step S15, one or more clusters of users are created based on one or more geolocations. It is contemplated that the server 24 may receive a plurality of geolocations originating from a plurality of mobile phones 3, 3a, 3b. In that case, one or more clusters can be created. In the one or more created clusters, the server 24 maintains the active mobile phones 3, 3a, 3b based on the server’s watchdog function described in connection with the step S12. For example, a cluster is built by calculating a geographical circle around a physical location and maintain a user community of known mobile phones 3, 3a, 3b. A cluster may include all (active) mobile phones 3, 3a, 3b at a worksite.

Proceeding to the step S16, it is checked if a token is available. If such a token has been created in the step S13, it is decided how to move forward. If a token is available, the process proceeds along the YES branch to the step S17, otherwise along the NO branch to the step S19. The token may indicate if the received information (geolocation, device ID, and name) belongs to an employee of the home company that operates the (back end) server 24.

In the step S17, the user-created safety profile is assigned to the mobile device 3 and, hence, the user 2. As mentioned above, an available token indicates that a previous user created a safety profile using a registration key. If the user does not have a token, the user continues without it and is automatically assigned the standard safety profile (see step S19). Proceeding to the step S18, the safety profile and the created token are sent to the app of the mobile phone 3.

In the step S19, if no token is available in the step S16, a standard safety profile is assigned to the mobile device 3 and, hence, the user 2. Such a standard safety profile is predetermined and stored in the server 24. Proceeding to the step S20, the standard safety profile is sent to the app of the mobile phone 3.

Referring to FIG. 4b, the process continues with the steps S22-S31. In the step S22, the respective safety profile assigned in the steps S17 or step S19 are received by the mobile phone 3. If a token is sent in the step S18, it is received as well in the step S22.

The mobile phone’s app uses the received profile to generate a checklist 23 that includes the PPE devices 4 the user 2 is supposed to wear. The app causes the checklist 23 to be displayed on the GUI 22, for example, as shown in FIG. 3. It is contemplated that the checklist 23 may be created while the user 2 is already at the worksite where wearing the PPE devices 4 is required, or still remote from that site, e.g., in a car or at the home company. With the checklist 23 being displayed, the safety system 1 is now ready for use by the user 2.

As the safety system 1 is used at the worksite, the user 2 is supposed to wear the PPE devices 4 while being present at the worksite. At this point in time, the user 2 must follow a safety protocol generally defined by the user’s home company and/or for the specific work assignment to be performed at the worksite; compliance with the safety protocol is verified by the safety system 1 using the app.

Each time the user 2 puts on one of the PPE devices 4 shown in FIG. 1 and closes the buckle 6 shown in FIG. 2, the RF module 8 on the PPE device 4 is ready for use, as described above with reference to FIG. 2. Following the safety protocol, the user 2 then scans the RF module 8 on each PPE device 4.

Proceeding to the step S23, the RF module 8 on the PPE device 4 is scanned when the user 2 holds the mobile phone 3 next to the buckle 6 of the PPE device 4. In one embodiment, if the safety profile requires several PPE devices 4, the safety profile may define in what sequence the user 2 has to scan the PPE devices 4. During the scanning of a PPE device 4, the mobile phone 3 reads the data stored on the microchip 14. In the embodiment illustrated in FIGS. 4a and 4b, the mobile phone 3 and its app are configured to process the read data (locally). In another embodiment, the mobile phone’s app is configured to send the read data (e.g., the unique identifier) to the server 24 and to receive instructions from the server 24.

Proceeding to the step S24, the data read by the scanning of the step S23 is verified against the safety profile received in the step S22. That is, as the data that identifies the PPE device 4 also specifies in one embodiment its kind (e.g., safety harness 4a or helmet 4c), the app can check if the currently scanned PPE device 4 is required according to the profile. For example, the read data may indicate that the PPE device 4 is a safety harness 4a; the safety harness 4a must then match the PPE device 4 (in the proper sequence, if any is specified) specified in the safety profile.

If it is determined that the read data indicates that the currently scanned PPE device 4 is worn by the user 2, as required according to the profile, the app causes the GUI 22 to display a checkmark next to the currently scanned PPE device 4, as indicated in FIG. 3. It is contemplated that the user 2 is required to repeat the scanning until all safety devices 4 (currently) worn by the user 2 have been scanned. After each scan, the displayed checklist 23 includes another checkmark next to the respective PPE device 4. Accordingly, the steps S23 and S24 (and certain subsequent steps) may be repeated at least once, as long as the list of actions specified in the safety profile is completed and the process has been complied with. FIG. 3 (upper part) shows one embodiment of the checklist 23 in which all listed PPE devices 4 are checked.

Proceeding to the step S25, after each scan it is determined if the profile can be verified as a whole or for each scanned PPE device 4 (e.g., regarding the proper sequence). If it is verified, the process proceeds along the YES branch to a step S25a and it is confirmed that the user 2 is in a safe state. The safe state may be communicated to the user 2; for example, the GUI 22 displaying a checkmark next to each PPE device 4 may be viewed as a safety confirmation. In one embodiment, the GUI 22 or only parts of it (e.g., the checkmarks) may be emphasized through coloring (e.g., using green). Other means of confirmation may be used as well (e.g., an audiovisual message).

In case one or not all PPE devices 4 are successfully checked, the process proceeds along the NO branch to a step S26 and it is determined that the user 2 is in an unsafe state. The unsafe state may be communicated to the user 2; for example, the GUI 22 displaying a warning or alert message “You are unsafe”, which may be an audiovisual message. The GUI 22 may indicate each unchecked PPE device 4, e.g., as indicated in FIG. 3 (lower part). In one embodiment, the GUI 22 or only parts of it (e.g., the unchecked PPE device 4) may be emphasized through coloring (e.g., using red). Other means of confirmation may be used as well.

At about the time the alert message is displayed in the step S26, a timer may be started to allow the user to scan the unchecked PPE device 4 (including in the proper sequence). For example, the timer may be set to 1-5 minutes, for example, 60 seconds. This gives the user 2 time to put on the PPE device 4 if the user 2 is not yet wearing the PPE device 4 and to (re)scan this PPE device 4, as indicated in the step S27.

In the step S27, the app may ask the user 2 if he wants to re-scan missing safety check points. If the user 2 confirms to re-scan the process returns along the YES branch to the step S23, otherwise the process proceeds along the NO branch to the step S28.

In the step S28, the mobile phone’s app determines the unsafe state of the user 2 and notifies the server 24 about that unsafe state by sending a corresponding notification (in FIG. 4b referred to as “Not OK”) to the server 24. The notification may include the mobile phone’s device ID.

Proceeding to the step S29, the geolocation cluster determined in the step S15 is validated with respect to the user 2. That is, the process determines the geolocation of the user 2 (e.g., the geolocation of the mobile phone 3) and any other active user (e.g. the geolocation of any other user’s mobile phone 3a, 3b) that is in proximity of the user 2, e.g., others that are in the user’s proximity cluster. In one embodiment, a (proximate) user (or mobile phone 3a, 3b) is defined as being in proximity of the user 2 when the user (or mobile phone 3a, 3b) is at the same worksite. All mobile phones 3a, 3b that are in proximity of the user 2 form a (geolocation) cluster. As described above, e.g., with reference to the step S15, the device ID of any such (proximate) mobile phone 3a, 3b is available to the server 24.

Proceeding to the step S30, an alert message (in FIG. 4b referred to as “Push Notifications”) is sent to any (active) mobile phone 3a, 3b in the (geolocation) cluster; for example, the server 24 sends the alert message to the respective mobile phone’s device ID. In one embodiment, the server 24 sends the alert message using a push notification. The technology for transmitting push messages (e.g., as used in instant messaging services) is known to the skilled person.

It is contemplated that in one embodiment a systematic escalation procedure may be implemented. For example, if the user 3 does not comply with the process specified by the safety profile the user’s supervisor and/or a service center may be alerted. Alerting the supervisor and/or the service center may take place in addition to alerting the users of the mobile phones 3a, 3b included in the (geolocation) cluster. Moreover, the supervisor and/or the service center may be alerted if there is no nearby co-worker.

Proceeding to the step S31, the alert message is received by a mobile phone 3a, 3b that is active and within the proximity cluster. In one embodiment, the mobile phone’s app communicates the alert message to its user. In the embodiment of FIG. 3 (lower part), the mobile phones 3a, 3b display one example of such an alert message (e.g., “Co-worker Unsafe”). It is contemplated that the alert message may be an audiovisual message as well. The alert message notifies the user of such a mobile phone 3a, 3b that a (nearby) user at the worksite is in an unsafe state. In response to noticing the alert message (e.g. by reading it), the user may approach any other nearby user, identify the “unsafe” user 2 and remind that user 2 of using the required PPE device 4. Having been reminded, the user 2 may scan the PPE devices 4, as described with reference to the step S23. In the illustrated embodiment, the step S31 represents the end of the process.

The foregoing description discloses a safety system 1 having the server 24 for communicating with the software application running on the mobile phone 3 of the user. The safety system 1 assists the user 2 to comply with the safety profile in that the software application generates the GUI 22 that shows the prescribed PPE devices 4 in form of a checklist 23. A PPE device 4 is provided with the magnet 18 and the RF module 8 having the magnetic switch 10. In use, when the user 2 properly wears the PPE device 4, the magnet 18 cause the magnetic switch 10 to close, and the RF module 8 is ready for being scanned by the user’s mobile phone 3. To comply with the safety profile, the user 2 must wear the PPE devices 4 and may be required to provide them in accordance with prescribed sequence. The safety system 1 provides for alerting nearby co-workers, a supervisor and/or a service center that the user 2 is in an unsafe state.

1. A method of operating a safety system comprising a server configured to wirelessly communicate with a first mobile communications device of a first user, wherein at least one personal safety equipment (PPE) device equipped with a radio frequency (RF) module is available to the first user, and wherein the first mobile communications device is provided with a software application configured to execute predetermined functions, wherein the predetermined functions comprise causing the first mobile communications device to display a graphical user interface comprising information related to the first user’s use of the PPE device, the method comprising:
transmitting by the server a set of instructions to the first mobile communications device being identified by a first device identifier, the set of instructions comprising a specification of a safety profile defined for the first user and causing the software application to display a checklist on the graphical user interface based on the safety profile, wherein the checklist lists the at least one PPE device;
receiving by the server a data signal from the first mobile communications device indicative of a status of the safety profile;
processing the received data signal to determine the status of the safety profile, the status being indicative of:
the safety profile being complied with and the first user having a safe status, or
the safety profile being not complied with and the first user having an unsafe state;
transmitting by the server a safe-state message to the first mobile communications device if the safety profile has been complied with; and
transmitting by the server an unsafe-state message to the first mobile communications device if the safety profile has not been complied with.

2-12. (canceled)

13. The method of claim 1, wherein the unsafe-state message specifies non-compliance of the safety profile.

14. The method of claim 13, wherein the unsafe-state messages specifies non-compliance with a sequence of steps specified by the safety profile.

15. The method of claim 13, wherein the unsafe-state messages specifies non-compliance due to the at least one PPE device remaining unchecked.

16. The method of claim 1, further comprising receiving by the server first location information from the first mobile communications device, the first location information being associated with the first device identifier, and determining from the first location information a first location at which the first user is located.

17. The method of claim 16, further comprising determining from second location information received by the server from a second mobile communications device being identified by a second device identifier a second location at which the second user is located, and determining if the second location is within a predetermined range to the first location.

18. The method of claim 17, further comprising generating and transmitting, based on the second device identifier, a first alert message to the second mobile communications device if the first user is in the unsafe-state and if the second location is within a predetermined range to the first location.

19. The method of claim 1, further comprising generating and transmitting a second alert message to at least one communications device assigned to a supervisor of the first user or a service center if the first user is in the unsafe-state.

20. The method of claim 1, further comprising receiving by the server user-identifying data, comprising in particular a user name or user code, and determining if the user-identifying data relates to a first user group or a second user group, wherein the first user is part of the first user group.

21. The method of claim 20, further comprising assigning a dedicated safety profile to the first user and assigning a standard profile to a user of the second user group, wherein the safety profile is dependent on the assigned safety profile or standard profile.

22. A safety system comprising:
at least one personal safety equipment (PPE) device for use by a first user, wherein the PPE device is equipped with a radio frequency (RF) module to be scanned by a first mobile communications device of the first user, wherein the first mobile communications device is provided with a software application configured to execute predetermined functions, wherein the predetermined functions comprise causing the first mobile communications device to display a graphical user interface comprising information related to the first user’s use of the PPE device;
a server configured to wirelessly communicate with the first mobile communications device of the first user, wherein the server comprises a processor and a computer-readable storage medium, the computer-readable storage medium comprising instructions that cause the processor to:
transmit a set of instructions to the first mobile communications device being identified by a first device identifier, the set of instructions comprising a specification of a safety profile defined for the first user and causing the software application to display a checklist on the graphical user interface based on the safety profile, wherein the checklist lists the at least one PPE device;
receive a data signal from the first mobile communications device indicative of a status of the safety profile;
process the received data signal to determine the status of the safety profile, the status being indicative of:
the safety profile being complied with and the first user having a safe status, or
the safety profile being not complied with and the first user having
an unsafe state;
transmit a safe-state message to the first mobile communications device if the safety profile has been complied with; and
transmit an unsafe-state message to the first mobile communications device if the safety profile has not been complied with.

23. The safety system of claim 22, wherein the frequency (RF) module of the PPE device is provided at a first part of a buckle and includes a transceiver with an antenna, a magnetic switch and a microchip, wherein a second part of the buckle includes a magnet, and wherein the magnet and the magnetic switch are positioned to be in close proximity when the buckle is closed and the magnet causes the magnetic switch to switch from an open state to a closed state closing an electrical circuit so that the RF module is operable.
